(19) United States
(12) Patent Application Publication
(10) Pub. No.: US 2015/0314881 A1
(43) Pub. Date: Nov. 5, 2015

(54) SAFETY APPARATUS FOR A MULTI-BLADE AIRCRAFT

(71) Applicant: WISEC LTD, Beer Sheva (IL)

(72) Inventors: Amir Tsaliah, Haifa (IL); Ran Krauss, Beer Sheva (IL)

(21) Appl. No.: 14/646,912

(22) PCT Filed: Nov. 25, 2013
(86) PCT No.: PCT/IL2013/050971

§ 371 Date: May 22, 2015

(30) Foreign Application Priority Data
Nov. 26, 2012 (IL) 223275

(51) Int. Cl. B64D 17/80; B64D 17/72

(52) U.S. Cl. CPC B64D 17/80; B64D 17/725

(57) ABSTRACT

The present invention provides safety apparatus for a multi-blade aircraft, comprising an expandable and collapsible parachute assembly having a plurality of inflatable tubes, a plurality of electrically triggered gas generators connected to a support surface of a multi-blade aircraft, and an on-board control unit for initiating triggering of said plurality of gas generators, wherein an outlet end of each of said plurality of gas generators is connected to, and in fluid communication with, a bottom end of one of said plurality of tubes, allowing said parachute assembly to be fully expanded upon generation of inflating gas by each of said plurality of gas generators.

### FIELD OF THE INVENTION

The present invention relates to the field of unmanned aerial vehicles (UAVs) or other light aerial vehicles. More particularly, the invention relates to safety apparatus for such an aircraft, particularly a multi-blade aircraft, to prevent damage to people and structures in the surroundings.

### BACKGROUND OF THE INVENTION

UAVs have undergone much development in recent years, for use in military and civilian applications.

The type of UAV on which the safety apparatus of the present invention is mounted is one that can fly and hover at very low altitudes (for example about 10 m) and are usually operated remotely. They can perform tasks that cannot be performed by helicopters or other aircraft such as pollution detection, close range aerial photography, and surveillance without being observed by imaging equipment.

Due to the low altitude of such aircraft, people and structures in the surroundings are liable to be severely damaged by moving fragments if the aircraft loses its ability to be controlled during flight and crashes.

It would therefore be desirable to provide a parachute for such a low flying UAV that is generally configured in a folded condition, yet could be fully deployed in a sufficiently short time to intercept, and therefore prevent damage from, UAV fragments during occurrence of a crash.

U.S. Pat. No. 4,105,173 discloses a parachute canopy that is supported in an open use position by an inflatable frame consisting of a network of inflatable lightweight flexible tubes, for use as an escape device from burning buildings or for sporting use. Bottled air or gas is utilized in order to inflate the device through an inflation valve. A harness suspended from the canopy is attachable to the body of a user. A restraining belt permits pre-inflation of the frame such that upon release, the canopy expands almost instantaneously by the straightening of folded flexible tubes.

This apparatus is not suitable for use in an UAV as the parachute, after being deployed in an opened condition, would become entangled in the blades of the UAV. Also, the parachute provides only limited buoyancy during descent of the user.

It is an object of the present invention to provide safety apparatus for a low flying UAV for setting a folded parachute to an opened condition in a sufficiently short time to intercept, and therefore prevent damage from, UAV fragments during occurrence of a crash involving the UAV.

It is an additional object of the present invention to provide safety apparatus for a low flying UAV which enables, when its parachute is set to an opened condition, significantly increased buoyancy with respect to prior art safety apparatus.

It is an additional object of the present invention to provide safety apparatus that prevents its parachute when set to an opened condition from being entangled in the blades of the UAV.

It is yet an additional object of the present invention to provide safety apparatus of relatively small dimensions and weight.

It is yet an additional object of the present invention to provide safety apparatus that prevents the main portion of a disabled UAV from causing damage to people and structures during its descent.

Other objects and advantages of the invention will become apparent as the description proceeds.

### SUMMARY OF THE INVENTION

The present invention provides safety apparatus for a multi-blade aircraft, comprising an expandable and collapsible parachute assembly having a plurality of inflatable tubes, a plurality of electrically triggered gas generators connected to a support surface of a multi-blade aircraft, and an on-board control unit for initiating triggering of said plurality of gas generators, wherein an outlet end of each of said plurality of gas generators is connected to, and in fluid communication with, a bottom end of one of said plurality of tubes, allowing said parachute assembly to be fully expanded upon generation of inflating gas by each of said plurality of gas generators.

As referred to herein, directional terms such as “bottom”, “top” and “upper” are described with respect to a normal orientation of the aircraft whereby the landing gear is downwardly positioned.

In one aspect, the control unit is also operable to deactivate rotation of the blades when the inflating gas is being generated.

In one aspect, the plurality of gas generators are configured to generate gas of a sufficiently high temperature to increase buoyancy of the parachute assembly when fully expanded.

In one aspect, the control unit is also operable to initiate inflation of an airbag assembly for absorbing force of impact at a bottom region of the aircraft in synchronization with a triggering event for expanding the parachute assembly.

### BRIEF DESCRIPTION OF THE DRAWINGS

In the drawings:

FIG. 1 is a perspective of a multi-blade aircraft to which the safety apparatus of the present invention is mounted;

FIG. 2 is a block diagram of safety apparatus including an undeployed parachute assembly, according to one embodiment of the present invention;

FIG. 3 is a perspective view of an exemplary configuration of the undeployed parachute assembly of FIG. 2, showing inflatable tubes thereof when separated from the canopy;

FIG. 4 is a perspective view of an exemplary configuration of the undeployed parachute assembly of FIG. 3, with the addition of suspension lines;

FIG. 5 is a perspective view of a plurality of canisters for generating inflating gas, when releasably connected to a base below;

FIG. 6 is a schematic illustration of a tube inflation event involving one of the canisters of FIG. 5;

FIG. 7 is a block diagram of safety apparatus including an undeployed parachute assembly, according to another embodiment of the present invention;

FIG. 8 is a perspective view of landing gear of a multi-blade aircraft, on which is mounted a schematically illustrated safety device;

FIG. 9 is a perspective view of the safety device of FIG. 8 when the airbag assembly is removed; and

FIG. 10 is a schematic illustration of an inflation event involving a tube of a parachute assembly and an airbag assembly.

### DETAILED DESCRIPTION OF PREFERRED EMBODIMENTS

Throughout this description the term “UAV” is used to indicate a class of light general aviation aircraft. This term does not imply any particular shape, construction material or geometry, and invention is applicable to all suitable light aviation aircraft such as unmanned aerial vehicles, Personal Aerial Vehicle (PAV) and the like.

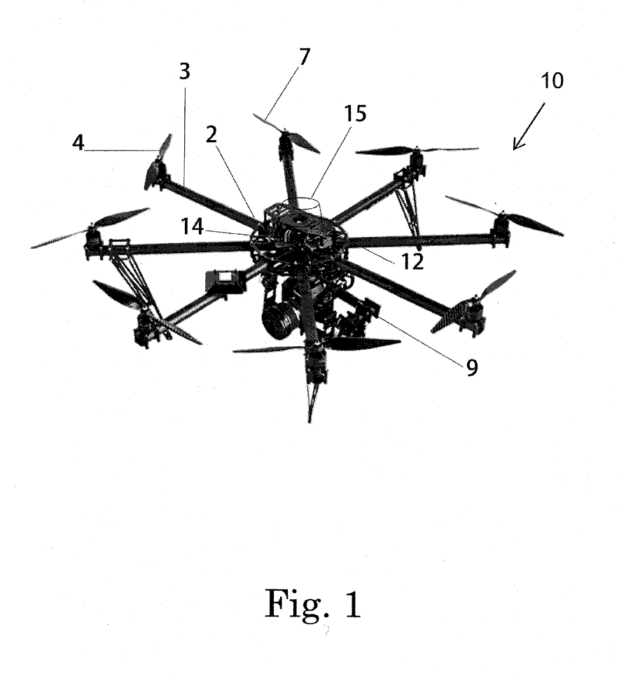

FIG. 1 illustrates an exemplary low flying, multi-rotor UAV 10 on which is mounted the schematically illustrated safety apparatus 15 of the present invention. UAV 10 comprises a hub 2, from which radially extends a corresponding arm 3 to each of a plurality of equally spaced rotors 4 and below which is positioned drive means 9 for each rotor 4. A blade 7 is fixed to each corresponding rotor 4 such that the rotor axis is vertically oriented when UAV 10 is in a normal upright position, allowing the UAV to perform vertical take-off and landing, as well as forward flight and hovering flight. A cage 12 for enclosing control equipment 14 vertically extends from hub 2, and safety apparatus 15 is mounted on top of cage 12 when its parachute is set to a normal folded condition.

It will be appreciated that safety apparatus 15 is also operable in conjunction with any other type of UAV.

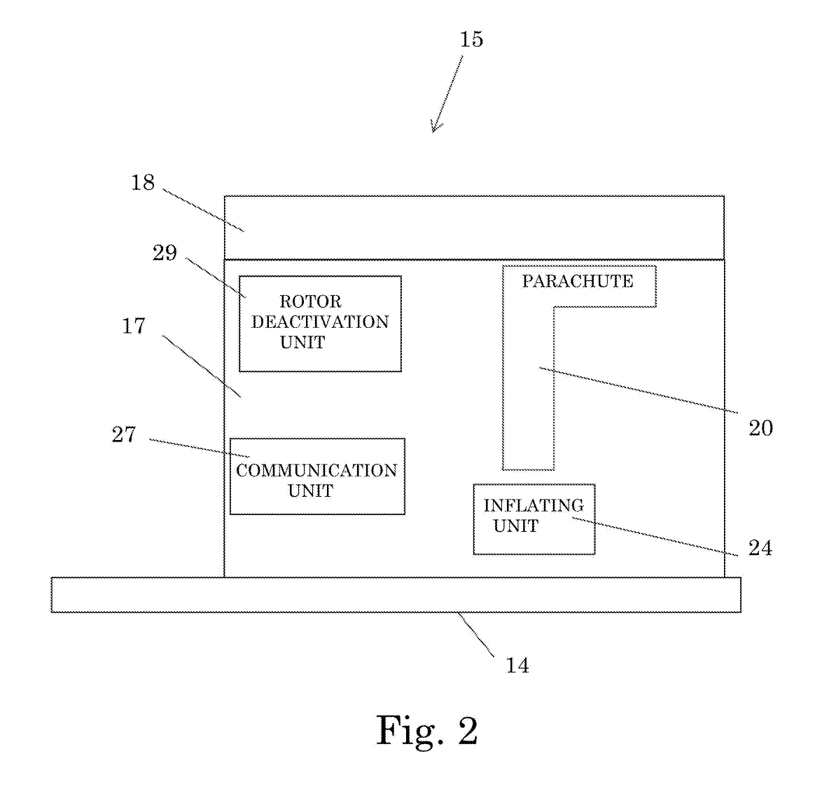

As schematically illustrated in FIG. 2, safety apparatus 15 is retained within a chamber 17 attached to a support element 14 of the UAV, e.g. the cage, and having a detachable lid 18. Safety apparatus 15 comprises, according to one embodiment of the invention, expandable parachute assembly 20 shown in a folded condition, inflating unit 24 for instantly inflating the frame of parachute assembly 20 upon demand, a wireless communication unit 27 for remotely controlling operation of the safety apparatus, and a rotor deactivation unit 29 synchronized with inflating unit 24 for preventing damage to the parachute when being expanded. Lid 18 becomes detached from chamber 17 when the parachute becomes sufficiently expanded so as to apply a force onto the lid. The entire safety apparatus 15 may weigh as little as 1-1.5 kg. For example, the safety apparatus may weighs less than 2 kg.

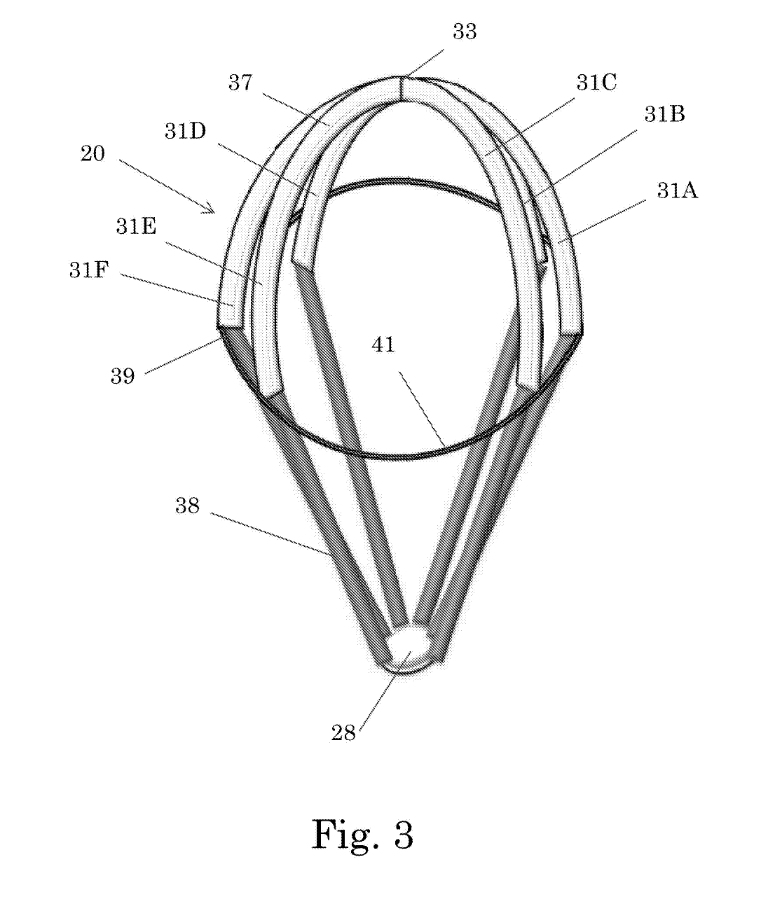

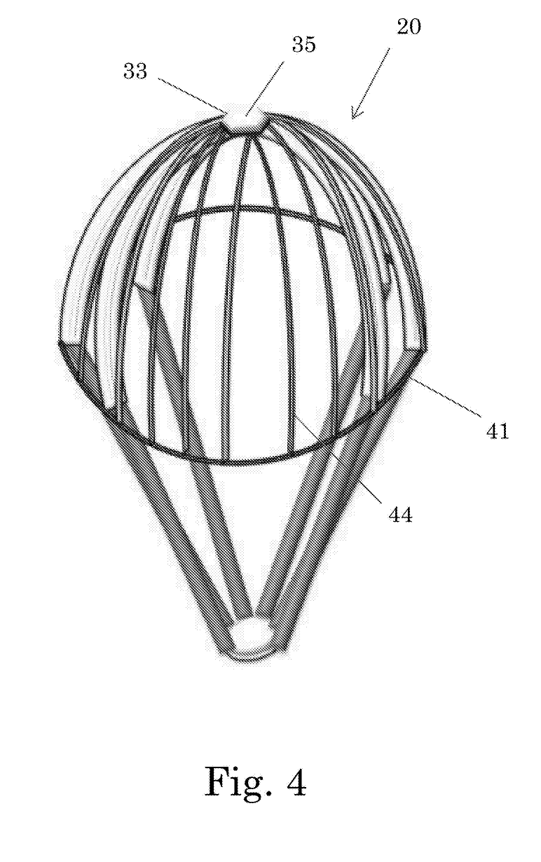

Parachute assembly 20 shown in FIGS. 3 and 4 comprises a plurality of equidistantly spaced inflatable tubes, e.g. six tubes 31A-F, arranged such that two opposing tubes define an inverted U. Each monolithic tube has an upper closed portion 37 to which is attached the parachute canopy, e.g. made of Kevlar, and a lower portion 38 through which the inflating gas is introduced. An intermediate weakened region 39 interfaces upper portion 37 and lower portion 38, allowing the corresponding tube to be folded.

Each tube, which is made of a flexible and structurally strong material that can withstand high temperatures, extends from a common lower, relatively rigid base 28, e.g. a circular base made of interwoven carbon and glass fibers, to a common upper terminal element 33, e.g. configured with a polygonal or annular shape, having an opening 35 internal to its periphery through which air upwardly flows in order to apply a force onto the parachute canopy.

A reinforcing annular belt 41 made of cloth, e.g. one that can withstand a wet and corrosive environment, is attached to each weakened region 39. Belt 41 urges the parachute into a desired umbrella shape for optimally capturing air and thereby maximizing drag while tubes 31A-F are being inflated. Circumferentially spaced and arcuate suspension lines 44 extending from terminal element 33 to belt 41 and applying a tensile force also assist in defining the shape of the canopy. When fully deployed, the parachute canopy may achieve a diameter of 2 m for a tube length of 3 m.

It will be appreciated that the parachute assembly may be configured in any other desired fashion.

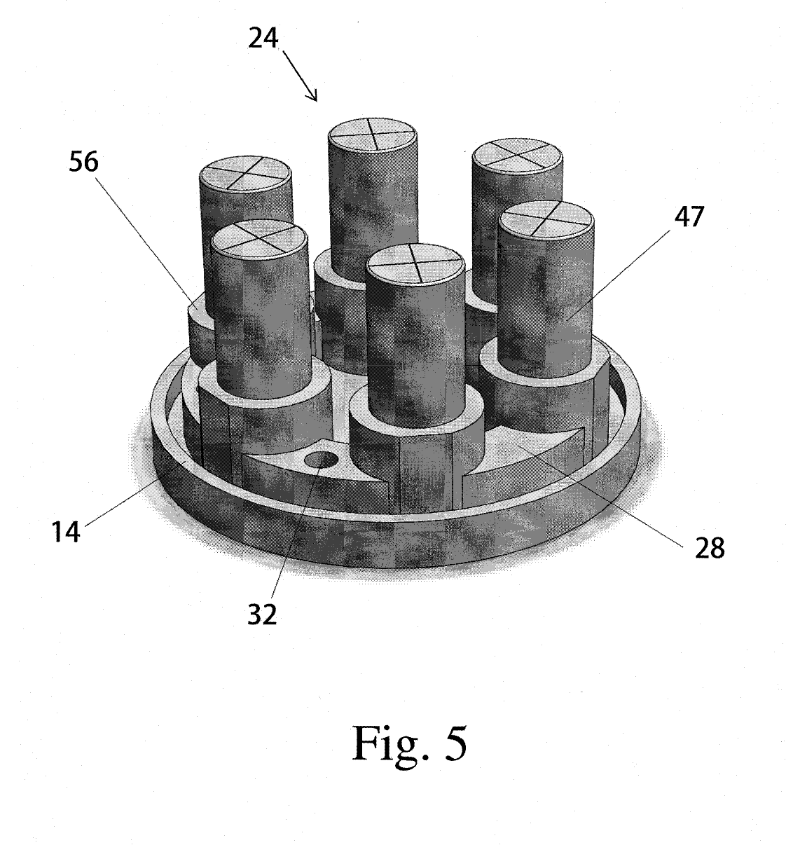

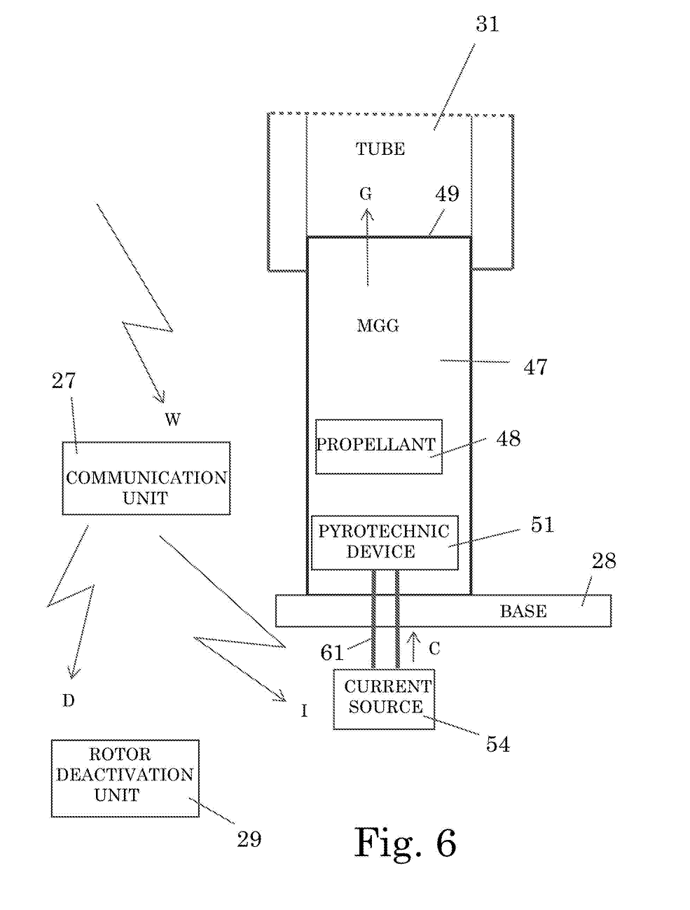

Referring now to FIGS. 5 and 6, inflating unit 24 comprises a plurality of vertically oriented canisters 47, one for each inflatable tube 31. Each of the canisters 47 is a micro gas generator (MGG) that contains a solid propellant 48 consisting of materials that normally do not chemically react with each other and a pyrotechnic device 51 for initiating a reaction with propellant 48. The bottom end of an inflatable tube 31 is connected to, and encloses, outlet end 49 of a corresponding canister 47, serving as means for anchoring the parachute to base 28. Tube 31 may be connected to outlet end 49 by means of pins that are introducible into corresponding apertures formed in canister 47 in a direction orthogonal to the force applied onto the parachute when deployed, or by any other connection means well known to those skilled in the art.

Alternatively, an intermediate tube (not shown) interfaces between an inflatable tube 31 and the outlet end 49 of a corresponding canister 47. That is, the bottom end of an inflatable tube 31 is connected to, and is in fluid communication with, the upper end of the intermediate tube, and the bottom end of the intermediate tube is connected to, and is in fluid communication with, outlet end 49 of the corresponding canister 47.

Each canister 47 is releasably connected to base 28, for example by means of a threaded ring 56 which is introduced to the canister at outlet end 49 thereof and is threadedly engageable with the base at the bottom of the canister. Although canister 47 is shown to be cylindrical, it may be configured in many different ways, for example one having a relatively thin outlet end and a relatively thick bottom end. Base 28 in turn is secured to underlying support element 14, for example by threaded bolts introduced into corresponding apertures 32 formed in the base. The canister 47 is of sufficiently small dimensions, e.g. having a diameter of 2 cm and a length of 7 cm, in order to be compactly stored in the retaining chamber when not in use, yet is highly efficient in terms of its gas generating capability. For example, the diameter of base 28 to which the plurality of canisters 47 are releasably connected may be less than 20 cm, e.g. 13 cm. A canister 47 is replaceable upon conclusion of a tube inflation event.

Pyrotechnic device 51 is activated by an electrical current source 54 for heating a conductor of the device above the ignition temperature of a combustible material in contact therewith. Ignition of the combustible material initiates the MGG, causing a rapid chemical reaction involving propellant 48 that generates a large volume of gas G such as nitrogen to fill and inflate a corresponding tube 31 and to thereby set the parachute canopy to an opened condition within less than a second.

The materials of propellant 48 and the current and voltage supplied by electrical current source 54 may be selected so as cause a highly exothermic reaction. The generated gas therefore serves not only to inflate tubes 31 and to cause the parachute canopy to expand, but also to increase the buoyancy of the parachute as a result of the high temperature of the gas, e.g. 170° C. Accordingly, the parachute is able to remain airborne sufficiently longer than prior art parachutes despite the heavy load of the UAV or of a UAV fragment to which it is attached.

In operation, an operator interacting with a remote flight controller transmits a wireless duress indicating signal W to the transceiver of communication unit 27 upon detection that the UAV has been subjected to conditions of duress requiring deployment of the parachute. After receiving signal W, communication unit 27 transmits a deactivation signal D for operating rotor deactivation unit 29, which is in electrical communication with a controller of the rotor drive means 9 (FIG. 1). Deactivation of the rotors will ensure that the expanding parachute will not become entangled with the rotating blades. Simultaneously with the transmission of signal D, or shortly thereafter, communication unit 27 transmits an initiation signal I to current source 54, which in turn generates a suitable current C for activating pyrotechnic device 51. Current C flows in parallel to the pyrotechnic device 51 of each canister 47 via contacts 61 extending from the bottom end of the corresponding canister. Activation of pyrotechnic device 51 causes the constituent components of propellant 48 to react and to generate gas G which causes a corresponding tube 31 to be rapidly inflated. The fully deployed parachute will be able to intercept moving UAV fragments, if any, and to sufficiently slow the descent of the disabled UAV so as to minimize damage of a collision involving the UAV.

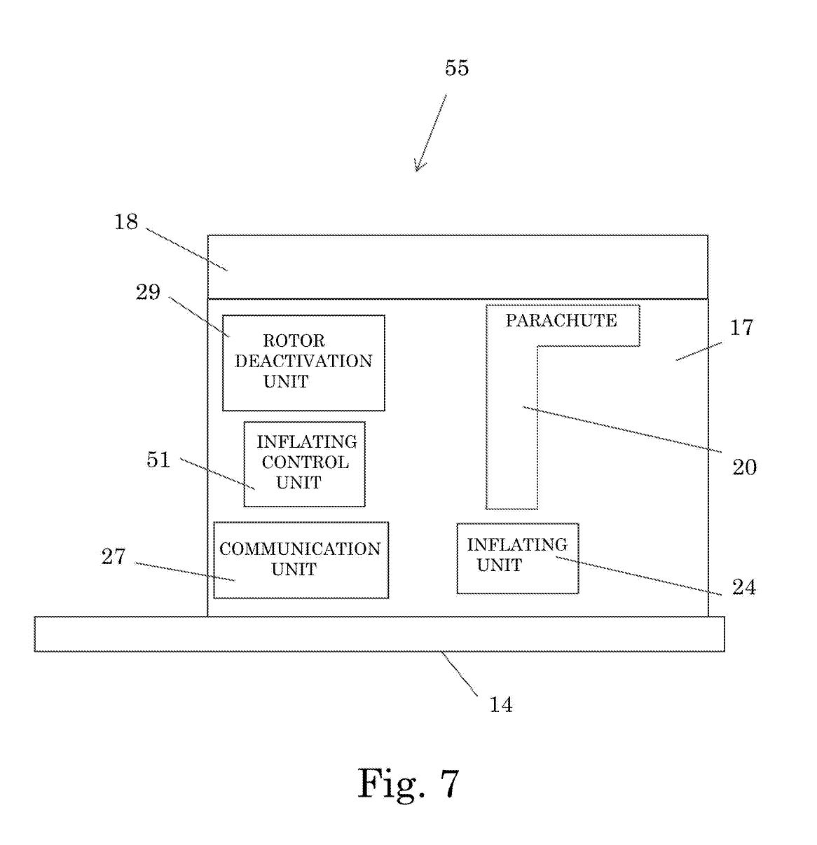

In another embodiment of the invention illustrated in FIG. 7, safety apparatus 55 comprises, in addition to those components shown in FIG. 2, an inflating control unit 51 for monitoring on-board sensors. Each sensor measures an in-flight parameter, including but not limited to impact, acceleration, speed, and orientation, and generates a signal that is transmitted to control unit 51. The sensor generated signals are processed according to predetermined rules stored in control unit 51. When the processed output is indicative of a duress condition such as an uncontrollable flight pattern or occurrence of an impact, control unit 51 electrically triggers the pyrotechnic device of each canister in order to ignite the propellant and generate the inflating gas.

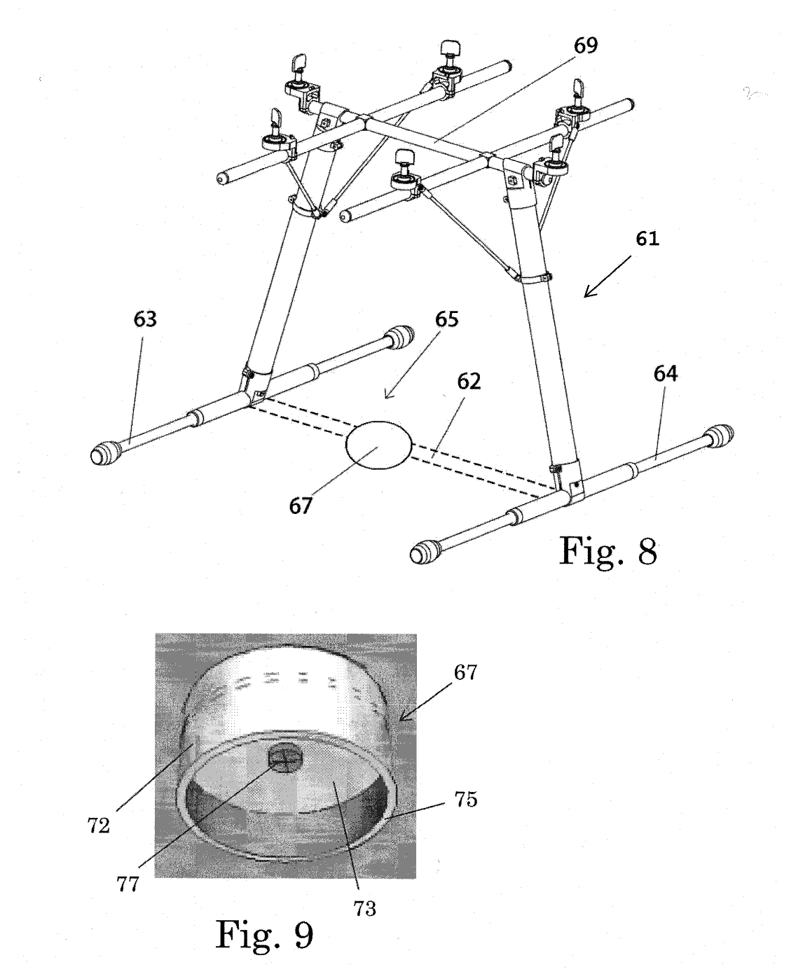

In another embodiment of the invention illustrated in FIG. 8, safety apparatus 65 comprises a device 67 for preventing damage to people or to structures after an UAV becomes physically damaged, such as after a crash, and is descending without control. Even though a deployed parachute assembly according to any of the embodiments described herein significantly slows the descent of the wrecked UAV, nevertheless the force of impact with a ground surface, or any other surface contacted by the UAV, is significant and will cause much damage.

Schematically illustrated device 67 is mounted on the landing gear 61 of the UAV, for example on a rod 62, e.g. having a length of 50 cm, connecting the two parallel skids 63 and 64 at the base of a strut 69. For example, rod 62 can be made of light weight materials, such as aluminum or carbon fibers.

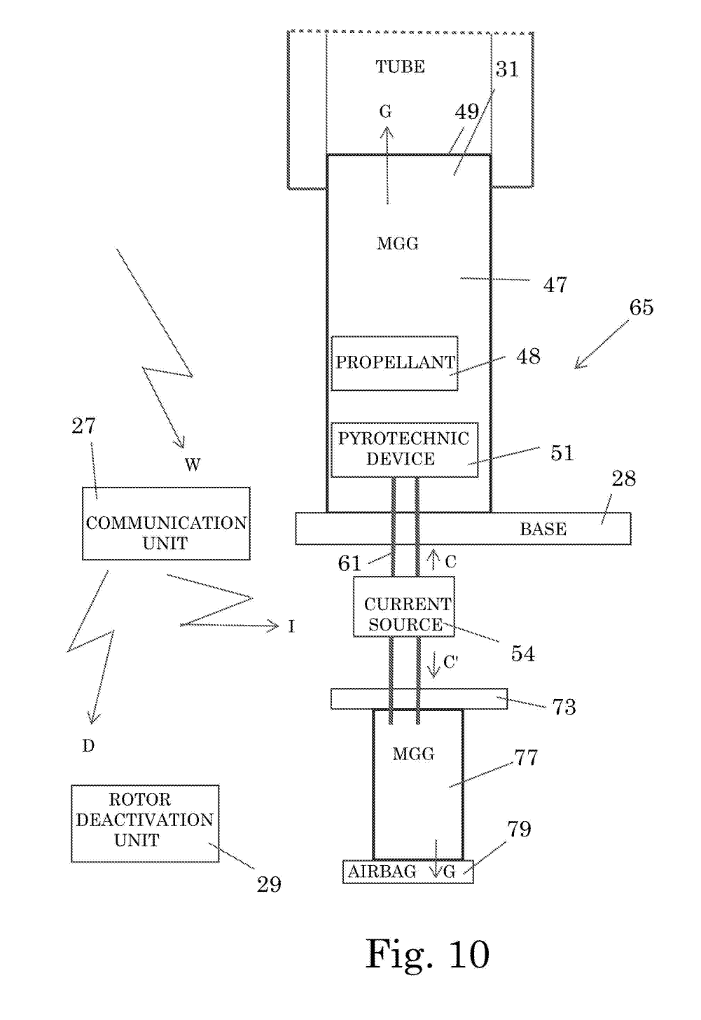

As shown in FIGS. 9 and 10, device 67 comprises a chamber 72 within which is retainable an undeployed airbag assembly. Chamber 72, which may be cylindrical and having a diameter of e.g. 10 cm, has a bottom annular rim 75 and a closed top 73 through which vertically extends a single gas generating canister 77. A lid (not shown) is detachably connected to rim 75. A port of the airbag assembly is connected to, and in fluid communication with, the outlet end at the bottom of canister 77. When a triggering initiation signal I is generated and transmitted to current source 54, a current C′ is directed to the pyrotechnic device of canister 77 simultaneously with the transmission of current C to each canister 47, or shortly thereafter, causing airbag 79 to be inflated and the lid to be detached. An inflated airbag will therefore be able to absorb the force of impact involving a disabled UAV.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. Safety apparatus for a multi-blade aircraft, comprising:
an expandable and collapsible parachute assembly having a plurality of inflatable tubes,
a plurality of electrically triggered gas generators connected to a support surface of the multi-blade aircraft, and
an on-board control unit operable to initiate triggering of said plurality of gas generators,
wherein an outlet end of each of said plurality of gas generators is connected to, and in fluid communication with, a bottom end of one of said plurality of inflatable tubes, allowing said parachute assembly to be fully expanded upon generation of inflating gas by each of said plurality of gas generators.

2. The safety apparatus according to claim 1, wherein the control unit is also operable to deactivate rotation of blades of the multi-blade aircraft when the inflating gas is being generated.

3. The safety apparatus according to claim 1, wherein the plurality of gas generators are configured to generate gas of a sufficiently high temperature to increase buoyancy of the parachute assembly when fully expanded.

4. The safety apparatus according to claim 1, wherein the control unit is operable to initiating triggering of the plurality of gas generators upon receiving a command signal from a remote flight controller.

5. The safety apparatus according to claim 1, wherein the control unit is operable to initiating triggering of the plurality of gas generators in response to a processed output of a plurality of on-board sensors which is indicative of a duress condition for the aircraft.

6. The safety apparatus according to claim 1, wherein each of the gas generators is releasably connected to a corresponding inflatable tube and to a base connected to the support surface.

7. The safety apparatus according to claim 6, wherein each of the gas generators is directly connected to the corresponding inflatable tube.

8. The safety apparatus according to claim 6, wherein an intermediate tube interfaces between each of the gas generators and the corresponding inflatable tube.

9. The safety apparatus according to claim 1, wherein the parachute assembly is expandable to a fully opened condition within less than a second following a gas generator triggering event.

10. The safety apparatus according to claim 1, wherein the control unit is also operable to initiate inflation of an airbag assembly for absorbing force of impact at a bottom region of the aircraft in synchronization with a triggering event for expanding the parachute assembly.

11. The safety apparatus according to claim 10, wherein the airbag assembly in an undeployed condition is retained in a chamber mounted on landing gear of the aircraft.

12. The safety apparatus according to claim 1, wherein the aircraft is an unmanned aerial vehicle.

13. The safety apparatus according to claim 1, wherein each of the plurality of gas generators has a diameter of less than 2.5 cm and a length of less than 7.5 cm.

14. The safety apparatus according to claim 3, wherein the temperature of the generated gas for increasing buoyancy of the parachute assembly when fully expanded is at least 160° C.
